(19) United States
(12) Patent Application Publication
(10) Pub. No.: US 2016/0349733 A1
(43) Pub. Date: Dec. 1, 2016

(54) Machine Performance Evaluation and Feedback System

(71) Applicant: Caterpillar Inc., Peoria, IL (US)

(72) Inventors: Sanat A. Talmaki, Peoria, IL (US); Jason Smallenberger, Morton, IL (US)

(73) Assignee: CATERPILLAR INC., Peoria, IL (US)

(21) Appl. No.: 14/726,043

(22) Filed: May 29, 2015

(51) Int. Cl. G05B 19/406

(52) U.S. Cl. CPC G05B 19/406; G05B 2219/31336

(57) ABSTRACT

A system provides feedback for a machine operation performed by a first machine with the machine operation corresponding to a first type of machine operation and including a quantitatively measurable tuning parameter associated therewith. The system includes a work implement for moving material at a work site to perform the machine operation and a controller. The controller is configured to generate a high performance reference based upon a plurality of reference operations performed by at least another machine with the plurality of reference operations corresponding to the first type of machine operation and determine a performance parameter for the machine operation performed by the first machine. The controller is further configured to compare the performance parameter to the high performance reference and generate a notice upon a difference between the performance parameter and the high performance reference exceeding a threshold.

### TECHNICAL FIELD

This disclosure relates generally to an evaluation and feedback system and, more particularly, to a system and method for evaluating and providing feedback in real time based upon a comparison of an operation to operations performed by other similar machines at a work site.

### BACKGROUND

Machines such as, for example, wheel loaders, track-type tractors, motor graders, dozers, and other mobile machines are used to perform a variety of operations associated with an industry such as mining, farming, construction, transportation, or any other industry. For example, these machines may be used to move material at a work site. The machines may operate in an autonomous, semi-autonomous, or manual manner to perform these tasks in response to commands generated as part of a work plan for the machines. The machines may receive instructions in accordance with the work plan to perform operations including digging, loosening, carrying, etc., different materials at the work site such as those related to mining, earthmoving and other industrial activities.

While desired performance thresholds or goals may be set for a particular machine or type of machine, material movement goals may not be met due to any of a plurality of factors that are dependent upon a particular work site. For example, the type of material being moved and/or environmental conditions at a work site may cause all or many machines to operate substantially below the desired goals.

In some instances, autonomously operated machines may remain consistently productive without regard to a human operator or environmental conditions. However, all machines operating at a work site may not be equally productive despite generally identical material moving plans. Systems may be used to determine instances in which a machine's performance is not meeting desired material moving goals.

U.S. Patent Publication No. 2003/0088321 discloses a method for compensating for variations in parameters of a plurality of machines having similar characteristics and performing similar operations. The method includes the steps of establishing a model development machine, obtaining data relevant to the modeled parameters, characteristics, and operations of each test machine, comparing the data from each test machine to corresponding data of the model development machine, and updating at least one of an estimator and a model of each test machine in response to variations in the compared data.

The foregoing background discussion is intended solely to aid the reader. It is not intended to limit the innovations described herein, nor to limit or expand the prior art discussed. Thus, the foregoing discussion should not be taken to indicate that any particular element of a prior system is unsuitable for use with the innovations described herein, nor is it intended to indicate that any element is essential in implementing the innovations described herein. The implementations and application of the innovations described herein are defined by the appended claims.

### SUMMARY

In one aspect, a system provides feedback for a machine operation performed by a first machine with the machine operation corresponding to a first type of machine operation and including a quantitatively measurable tuning parameter associated therewith. The system includes a work implement for moving material at a work site to perform the machine operation and a controller. The controller is configured to generate a high performance reference based upon a plurality of reference operations performed by at least another machine with the plurality of reference operations corresponding to the first type of machine operation and determine a performance parameter for the machine operation performed by the first machine. The controller is further configured to compare the performance parameter to the high performance reference and generate a notice upon a difference between the performance parameter and the high performance reference exceeding a threshold.

In another aspect, a method provides feedback for a machine operation performed by a first machine with the machine operation corresponding to a first type of machine operation and including a quantitatively measurable tuning parameter associated therewith. The method includes generating a high performance reference based upon a plurality of reference operations performed by at least another machine with the plurality of reference operations corresponding to the first type of machine operation, determining a performance parameter for the machine operation performed by the first machine as a work implement moves material at a work site, comparing the performance parameter to the high performance reference, and generating a notice upon a difference between the performance parameter and the high performance reference exceeding a threshold.

In still another aspect, a machine includes a propulsion system for moving the machine, a work implement for moving material at a work site to perform the machine operation with the machine operation corresponding to a first type of machine operation and including a quantitatively measurable tuning parameter associated therewith, and a controller. The controller is configured to generate a high performance reference based upon a plurality of reference operations performed by at least another machine with the plurality of reference operations corresponding to the first type of machine operation and determine a performance parameter for the machine operation performed by the first machine. The controller is further configured to compare the performance parameter to the high performance reference and generate a notice upon a difference between the performance parameter and the high performance reference exceeding a threshold.

### BRIEF DESCRIPTION OF THE DRAWINGS

FIG. 1 depicts a schematic illustration of a work site at which a plurality of machines incorporating the principles disclosed herein may be used;

FIG. 2 depicts a schematic illustration of a wheel loader;

FIG. 3 depicts a schematic illustration of a wireless communications system;

FIG. 4 depicts a schematic illustration of a second work site at which a second plurality of machines incorporating the principles disclosed herein may be used; and

FIG. 5 depicts a flowchart illustrating an evaluation and feedback system used at the work site of FIG. 1.

### DETAILED DESCRIPTION

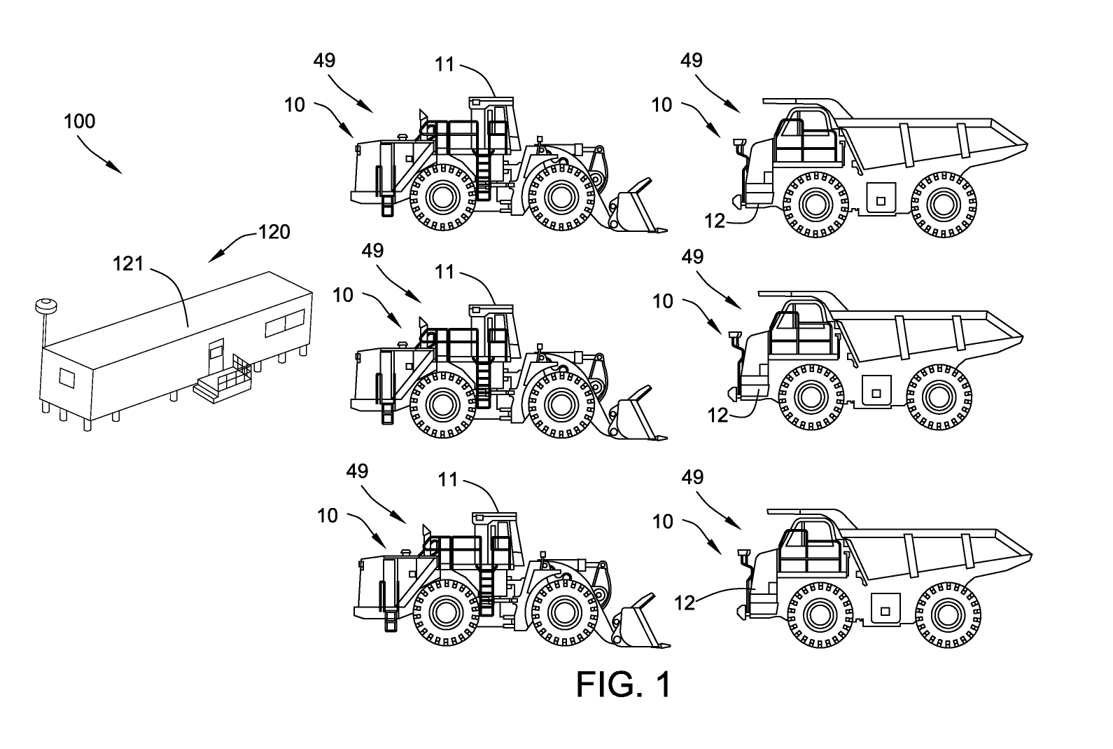

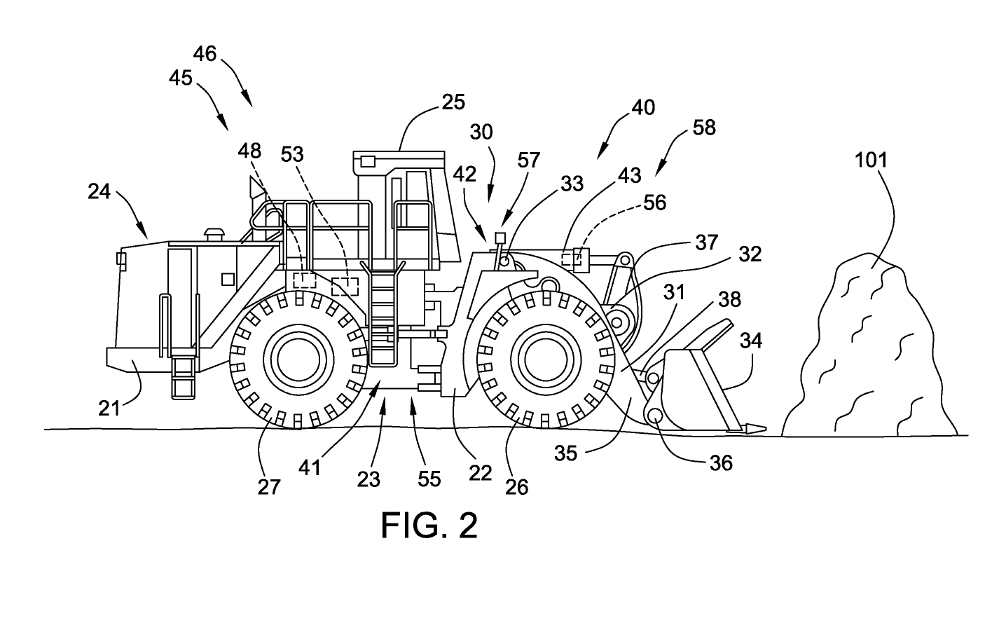

FIG. 1 illustrates an exemplary work site 100 at which a plurality of mobile machines 10 may operate in an autonomous, a semi-autonomous, or a manual manner. Work site 100 may include, for example, a mine site, a landfill, a quarry, a construction site, a road work site, or any other type of work site. Machines 10 may perform any of a plurality of desired operations or tasks at work site 100, and such operations or tasks may require the machine to generally traverse work site 100. Any number of machines 10 may simultaneously and cooperatively operate at work site 100, as desired. Each machine 10 may embody any type of machine such as the wheel loaders 11 and haul trucks 12 depicted in FIG. 1, service trucks, dozers, excavators, or another types of mobile machines known in the art. As depicted, work site 100 includes a plurality of wheel loaders 11 used to load material 101 (FIG. 2) onto a plurality of machines such as haul trucks 12. After each haul truck 12 is filled to a desired level, the haul truck 12 may travel to dump location before returning to be filled again.

As used herein, a machine 10 operating in an autonomous manner operates automatically based upon information received from various sensors without the need for human operator input. As an example, a load or haul truck that automatically follows a path from one location to another and dumps a load at an end point may be operating autonomously. A machine operating semi-autonomously includes an operator, either within the machine or remotely, who performs some tasks or provides some input, and other tasks are performed automatically and may be based upon information received from various sensors. As an example, a haul truck that automatically follows a path from one location to another but relies upon an operator command to dump a load may be operating semi-autonomously. In another example of a semi-autonomous operation, an operator may dump a bucket of an excavator in a haul truck and a controller may automatically return the bucket to a position to perform another digging operation. A machine being operated manually is one in which an operator is controlling all or essentially all of the functions of the machine. A machine may be operated remotely by an operator (i.e., remote control) in either a manual or semi-autonomous manner.

FIG. 2 is a diagrammatic illustration of a wheel loader 11 that may be used in accordance with an embodiment of the disclosure. The wheel loader 11 may include a body having a base portion 21 and an implement support portion 22 pivotally mounted on the base portion by an articulating joint 23. The base portion 21 houses a prime mover 24 such as an engine and an operator station or cab 25 in which an operator may be positioned. The prime mover 24 is operatively connected to and drives a ground engaging drive mechanism such as front wheels 26 and rear wheels 27 to operate as a propulsion system. The base portion 21 includes the rear wheels 27 while the implement support portion 22 includes the front wheels 26. The articulating joint 23 permits the implement support portion 22 to pivot or move relative to the base portion 21 for purposes of steering the machine 10.

The implement support portion 22 includes a linkage 30 having one or more lift arms 31 pivotally connected to the implement support portion 22 at first pivot joint 33. A work implement such as bucket 34 may be pivotally mounted at a distal end 35 of the lift arms 31 at a second pivot joint 36. A curl lever 37 may be pivotally mounted on curl lever support member 32 of implement support portion 22 with a first end (not shown) connected to a curl link member 38 that is pivotally connected to bucket 34. With this configuration, rotation of the curl lever 37 results in curling or tilting of the bucket 34 about the second pivot joint 36.

The machine 10 may include a system such as an electro-hydraulic system generally indicated at 40 for operating various systems and components of the machine. A pair of steering cylinders 41 (only one being visible in FIG. 2) extends between the base portion 21 and the implement support portion 22 and operate to control the movement of the implement support portion relative to the base portion about the articulating joint 23 to control the steering of the machine 10. A pair of lift cylinders shown generally at 42 may operatively extend between the implement support portion 22 to the lift arms 31 to facilitate raising and lowering of the lift arms about first pivot joint 33. A curl cylinder 43 may operatively extend between the implement support portion 22 and the curl lever 37 to facilitate rotation or tilting of the bucket 34 about second pivot joint 36. The steering cylinders 41, the lift cylinders 42, and the curl cylinder 43 may be electro-hydraulic cylinders or any other type of desired cylinders.

Machine 10 may include a control system 45, as shown generally by an arrow in FIG. 2 indicating association with the machine. The control system 45 may utilize one or more sensors to provide data and input signals representative of various operating parameters of the machine 10 and the environment of the work site 100 at which the machine is operating. The control system 45 may include an electronic control module or controller 46 as shown generally by an arrow in FIG. 2 indicating association with the machine and a plurality of sensors associated with the machine 10.

The controller 46 may be an electronic controller that operates in a logical fashion to perform operations, execute control algorithms, store and retrieve data and other desired operations. The controller 46 may include or access memory, secondary storage devices, processors, and any other components for running an application. The memory and secondary storage devices may be in the form of read-only memory (ROM) or random access memory (RAM) or integrated circuitry that is accessible by the controller. Various other circuits may be associated with the controller 46 such as power supply circuitry, signal conditioning circuitry, driver circuitry, and other types of circuitry.

The controller 46 may be a single controller or may include more than one controller disposed to control various functions and/or features of the machine 10. The term “controller” is meant to be used in its broadest sense to include one or more controllers and/or microprocessors that may be associated with the machine 10 and that may cooperate in controlling various functions and operations of the machine. The functionality of the controller 46 may be implemented in hardware and/or software without regard to the functionality. The controller 46 may rely on one or more data maps relating to the operating conditions and the operating environment of the machine 10 and the work site 100 that may be stored in the memory of controller. Each of these data maps may include a collection of data in the form of tables, graphs, and/or equations.

The control system 45 and controller 46 may be located on the machine 10 as an on-board control system 47, as shown generally by an arrow in FIG. 2 indicating association with the machine, with an on-board controller 48, or may be distributed with components also located remotely from the machine such as at a command center 120 (FIG. 1). The functionality of control system 45 may be distributed so that certain functions are performed at machine 10 and other functions are performed remotely. In one example, the control system 45 may include a communications system such as wireless network system 121 (FIG. 1) for transmitting signals between the machine 10 and a system located remote from the machine such as at the command center.

In another example, the control system 45 may also or alternatively include a short range machine-to-machine or peer-to-peer communications system 49. Peer-to-peer communications system 49 may include components to enable each machine 10 to send and receive signals to and from other machines over a relatively short distance without the need for a network node remote from the machines.

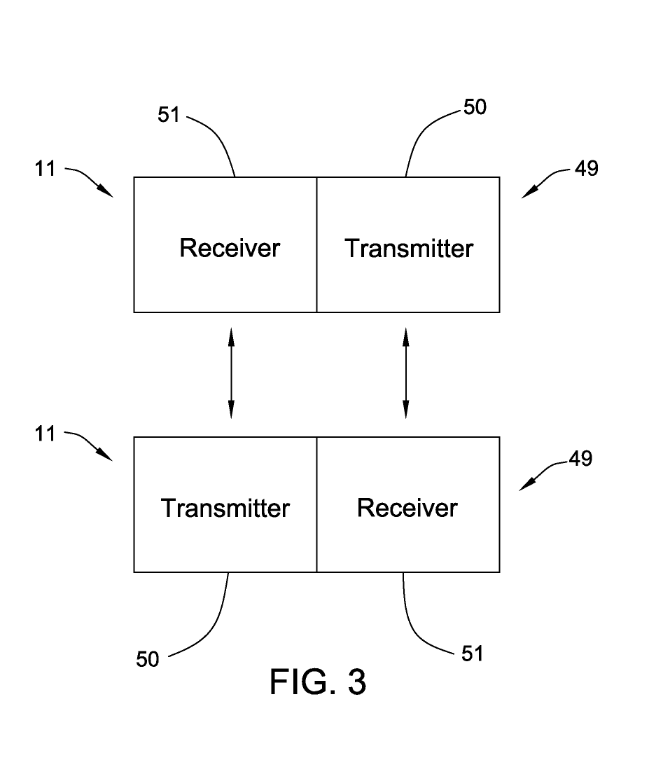

In one embodiment depicted in FIG. 3, each peer-to-peer communications system 49 may include a peer-to-peer transmitter system 50 for transmitting signals from one peer-to-peer communications system and a peer-to-peer receiver system 51 for receiving signals from a peer-to-peer transmitter system of another peer-to-peer communications system. In some instances, the peer-to-peer transmitter system 50 and the peer-to-peer receiver system 51 may be combined as a transceiver system. In other instances, a machine may only include a peer-to-peer transmitter system.

Peer-to-peer communications system 49 may implement any desired protocol including any of a plurality of communications standards. The desired protocols will permit communication between machines over a relatively short distance without the need for a network node or network access point remote from the machines. In one example, the range of the peer-to-peer communications system may be 30 m or less. In addition, in order to reduce latency and simplify the system, for systems that include a network node or access point, such network nodes or access points may be located or positioned on one of the machines between which communication is being effected.

In one example, the peer-to-peer communications system 49 may utilize a wireless personal area network such as Bluetooth® LE (“Bluetooth® Smart”) or another personal area network or a local area network such as IEEE 802.11b, 802.11g, 802.11p, 802.15.4, WiFi Direct, or LTE Direct. In a system utilizing a Bluetooth® Smart system or protocol, the peer-to-peer communications system 49 may operate to automatically pair the communications systems of two machines 10 and then transmit signals directly between the peer-to-peer communications systems of the machines. In another embodiment, one of the machines 10 may include a network node with which each peer-to-peer communications system 49 may communicate. In still another example, a network node may be activated on one of the peer-to-peer communications systems 49 and the peer-to-peer communications systems communicate through the network node.

Other communications systems and configurations are contemplated. For example, machines 10 may communicate with each other through the peer-to-peer communications system 49 as well as communicate with the command center 120 through wireless network system 121.

Referring back to FIG. 2, machine 10 may be equipped with a plurality of machine sensors that provide data indicative (directly or indirectly) of various operating parameters of the machine and/or the operating environment in which the machine is operating. The term “sensor” is meant to be used in its broadest sense to include one or more sensors and related components that may be associated with the machine 10 and that may cooperate to sense various functions, operations, and operating characteristics of the machine and/or aspects of the environment in which the machine is operating.

A position sensing system 52, as shown generally by an arrow in FIG. 2 indicating association with the machine 10, may include a position sensor 53, also shown generally by an arrow in FIG. 2 to indicate association with the machine, that is operative to sense the position of the machine relative to the work site 100. The position sensor 53 may include a plurality of individual sensors that cooperate to generate and provide position signals to controller 46 indicative of the position of the machine 10. In one example, the position sensor 53 may include one or more sensors that interact with a positioning system such as a global navigation satellite system or a global positioning system to operate as a position sensor. The controller 46 may use position signals from the position sensor 53 to determine the position of the machine 10 within work site 100. In other examples, the position sensor 53 may include an odometer or another wheel rotation sensing sensor, a perception based system, or may use other systems such as lasers, sonar, or radar to determine all or some aspects of the position of machine 10.

An articulating joint position sensor 55, as shown generally by an arrow in FIG. 2, may be provided and is operative to sense the angular position of the implement support portion 22 relative to the base portion 21 as it rotates about the articulating joint 23. In one embodiment, the articulating joint position sensor 55 may be configured as a displacement sensors (not shown) associated with each of the steering cylinders 41. The displacement sensors may generate and provide displacement signals to controller 46 indicative of the displacement of each of the steering cylinders 41. The controller 46 may analyze the displacement signals from each steering cylinder 41 to determine the displacement of each steering cylinder and then determine the angular orientation of the implement support portion 22 relative to the base portion 21 based upon the relative positions of the steering cylinders.

A lift position sensor 57, as shown generally by an arrow in FIG. 2, may be provided and is operative to sense the angular position of the lift arms 31 relative to the implement support portion 22 as the lift arms rotate about the first pivot joint 33. In one embodiment, the lift position sensor 57 may be configured as a displacement sensor (not shown) associated with one or more of the lift cylinders 42. The displacement sensors may generate and provide displacement signals to controller 46 indicative of the displacement of the lift cylinders 42. The controller 46 may analyze the displacement signals from the displacement sensors to determine the position of the lift arms 31 based upon the position of the lift cylinders and the dimensions of the lift arms and lift cylinders 42. In other words, based upon the extent to which the lift cylinders 42 are extended, the controller 46 may determine the angle of the lift arms 31 relative to the implement support portion 22.

A curl position sensor 58, as shown generally by an arrow in FIG. 2, may be provided and is operative to sense the angular position of the bucket 34 relative to the lift arms 31 as the bucket rotates about the second pivot joint 36. In one embodiment, the curl position sensor 58 may be configured as a displacement sensor 56 associated with the curl cylinder 43. The displacement sensor 56 may generate and provide displacement signals to controller 46 indicative of the displacement of the curl cylinder 43. The controller 46 may analyze the displacement signals from the displacement sensor 56 to determine the position of the bucket 34 based upon the position of the curl cylinder 43 and the dimensions of the curl lever support member 32, curl lever 37, curl link member 38, and curl cylinder 43. Based upon the extent to which the curl cylinder 43 is extended, the controller 46 may determine the angle of the bucket 34 relative to the lift arms 31.

Other types of sensors such as, for example, rotary potentiometers may be used rather than cylinder displacement sensors to determine the relative angles between the pivotable components (i.e., implement support portion 22 relative to base portion 21, lift arms 31 relative to implement support portion 22, and bucket 34 relative to lift arms 31). Additional sensors may be provided, if desired, to generate signals indicative of the relative angular velocity and angular acceleration between the pivotable components as they rotate about their pivot joints. In an alternate embodiment, controller 46 may be configured to determine the relative angular velocity and angular acceleration based upon the signals from the different position sensors. For example, controller 46 may monitor or determine the rate of change of the relative positions of the components to determine the angular velocity.

Each machine 10 may be used to perform many different operations. In many instances, the operators may be performing repetitive operations over an extended period of time. Controller 46 may include a performance evaluation and feedback system 60 that is operative to analyze a machine's performance, compare the performance or productivity to those of other machines, and provide information and feedback to various personnel and systems including providing instructions or suggestions to improve an operator's performance. The controller 46 may analyze the productivity of a machine 10 based upon certain performance parameters, and compare the performance of that machine to the performance of other machines. Quantifiably measurable tuning parameters may be determined for each machine and machine operation adjusted to follow one or more of the tuning parameters associated with the highest machine performance.

Tuning parameters may be established or determined by segmenting or braking down an operation into a plurality of quantitatively measurable tasks that may be evaluated based upon desired positions and speeds of the machine 10 and its various components. The performance of each task or tuning parameter may be measured during each material moving operation.

As an example, a machine 10 configured as a wheel loader 11 may be used to repeatedly dig into a pile of loose material 101 such as gravel or dirt with bucket 34, lift a bucket load of material, and subsequently move the bucket load of material to a desired location such as within a haul truck 12. The productivity of the machine operation may be evaluated by determining one or more performance parameters for the material moving operations. These performance parameters may include the length of time per pass or loading cycle, the volume per loading cycle, the fuel consumed per loading cycle, the waiting time for a haul truck 12, as well as any other desired parameters.

The tuning parameters may be generated by segmenting the operation of digging into the pile of material and loading the bucket 34 into a plurality of sequential tasks such as the relative or absolute positions and/or speeds of movement of the machine 10 and its various components (e.g., lift arms 31 and bucket 34).

A material moving operation may be segmented into any number of desired tuning parameters. One example of a tuning parameter may be the angle between the base portion 21 and the implement support portion 22 of the wheel loader 11 as the bucket 34 enters the pile of material 101. The controller 46 may determine the angle based upon data from the articulating joint position sensor 55 as described above. A second example of a tuning parameter may be the angle of the bucket 34 relative to the ground or pile of material 101 as the bucket enters the material. The controller 46 may determine the angle of the bucket 34 based upon data from the position sensor 53 and the curl position sensor 58.

A third example of a tuning parameter may be whether the bucket 34 is being curled while penetrating the pile of material 101. In doing so, it is typically desirable to move the machine 10 with the bucket 34 into the pile of material, slightly curl the bucket, move the machine forward farther into the pile of material and then slightly curling the bucket an additional amount so that additional material will be gathered into the bucket. The process may be continued until the bucket is completely filled. The controller 46 may determine the rate and timing of the bucket curling tuning parameter based upon data from the curl position sensor 58 as well as data from the position sensor 53 as the machine 10 moves into the pile of material 101.

A fourth example of a tuning parameter may be whether the lift arms 31 are being used to fill the bucket 34 rather than utilizing the curl cylinder 43 and the forward movement of the machine 10. In other words, when filling bucket 34, it may be generally desirable for the lift arms 31 not to be raised significantly. The controller 46 may determine the amount that the lift arms 31 have been raised based upon data from the lift position sensor 57. A fifth example of a tuning parameter may be the gear in which the machine is being operated as the bucket 34 engages the pile of material 101 and the bucket is filled. In general, it may be desirable for the machine to be first gear during the bucket filling operation.

A sixth example of a tuning parameter may be the speed of the machine 10 as it engages the pile of material 101. A seventh example of a tuning parameter may be the distance between the pile of material 101 and the haul truck 12.

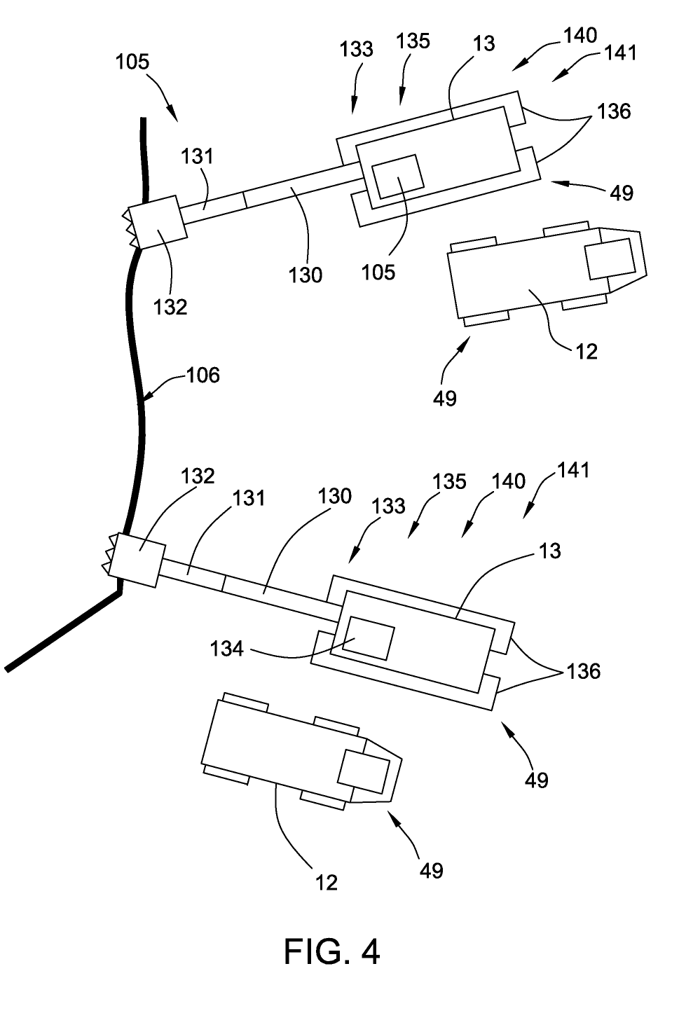

Referring to FIG. 4, an additional example of a material moving operation is depicted. A pair of excavators 13 together with haul trucks 12 are depicted at a second work site 105. Each excavator 13 may include an implement system having a boom member 130, a stick member 131, and a bucket 132. The implement system may be operatively connected to a hydraulic system generally indicated at 133 including hydraulic cylinders or actuators (not shown) for causing movement of the implement system. An operator may operate the excavator 13 from an operator station or cab 134. A prime mover 135 is operatively connected to and drives a ground engaging drive mechanism such as tracks 136.

The excavators 13 may each include a control system 140 and controller 141 identical or similar to control system 45 and controller 46 described above and the descriptions thereof are not repeated. As such, each excavator 13 may also include a peer-to-peer communications system 49 as described above.

Examples of performance parameters for the material moving operations performed by excavators 13 may include the length of time per pass or loading cycle, the volume or payload for loading cycle, the fuel consumed for loading cycle, the waiting time for a haul truck 12, the total swing time (e.g., the time from filling the bucket 132 to the time that the bucket is dumped in the haul truck), as well as any other desired parameters. Examples of tuning parameters may include the swing angle (e.g., the angle from the dig location 106 to the dump location), the swing speed, elevation differences between the dig location and the dump location, as well as any other desired parameters.

From the forgoing, it may be understood that the productivity of each material moving operation may be measured based on one or more performance parameters. By breaking or segmenting each operation into a plurality of tuning parameters, aspects of each operation may be evaluated and adjusted in order to optimize or improve the material moving operation.

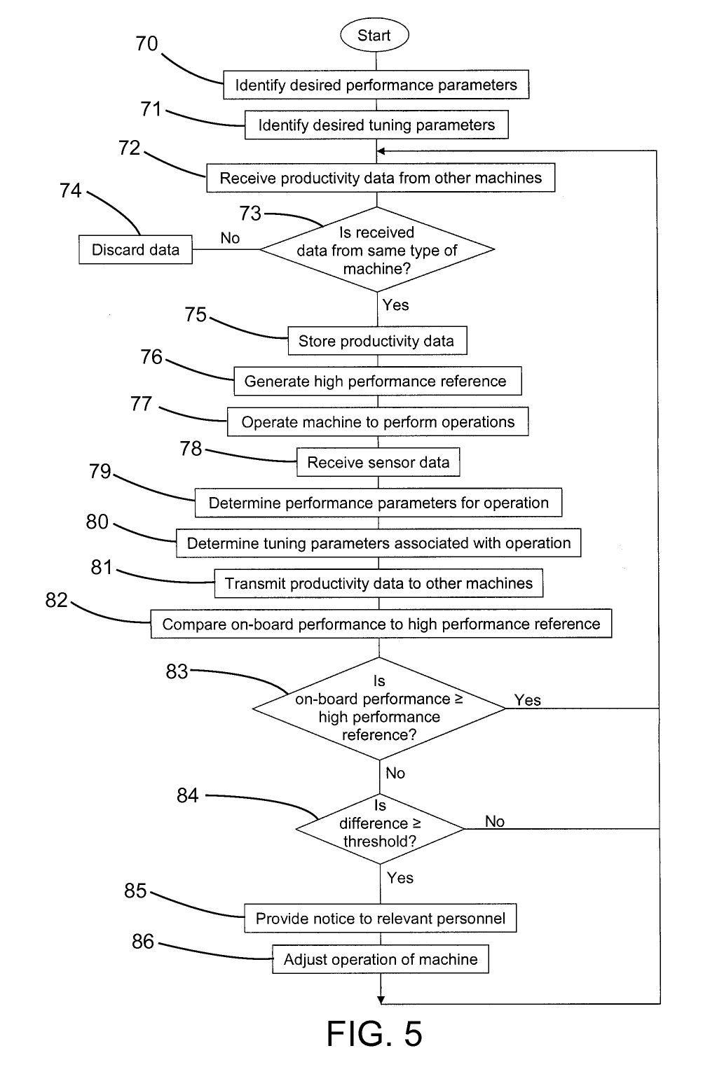

FIG. 5 illustrates the operation of the performance evaluation and feedback system 60 for evaluating and adjusting the performance of material moving operations. At stage 70, desired performance parameters associated with a type of material moving operation may be identified and stored within on-board controller 48. One or more tuning parameters for each type of material moving operation may be identified and stored at stage 71 within on-board controller 48.

As used herein, a type of material moving operation refers to a process for moving material with each process having similar characteristics and steps. For example, a plurality of wheel loaders 11 may repeatedly dig into a pile of material and load one or more haul trucks 12. Even if each wheel loader 11 does not follow an identical path or move its linkage 30 and bucket 34 in an identical manner, the process of loading the haul trucks 12 through the use of the wheel loaders may be considered a single type of material moving operation.

In some instances, it may be desirable for the models or types of wheel loaders 11 to be generally similar, substantially similar, or even identical, so that the details or tuning parameters of each material moving operation may be similar enough so as to make a comparison of different material moving operations of the same type useful. Thus, while using one or more excavators 13 to load one or more haul trucks 12 may also be considered a single type of material moving operation, such material moving operations would not be considered the same type as the material moving operations performed by a wheel loader 11, even though both result in loading of a haul truck.

At stage 72, on-board controller 48 may receive productivity data from other machines 10. The productivity data may include performance parameters for each material moving operation performed by the other machines 10 as well as the tuning parameters associated with each such material moving operation. These material moving operations define a plurality of reference operations corresponding to a specific type of machine operation and may be used to generate productivity data that is used to define target or desired performance at the work site 100 for that type of machine operation.

In one embodiment, the machine 10 may receive the data through the peer-to-peer communications system 49 associated with the other machines 10 operating at the work site 100 working within a predetermined range (such as the range of the peer-to-peer communications system) from the machine receiving the data. In another embodiment, the machines 10 may share or pass on data received from other machines through the peer-to-peer communications system 49 so that the range of data sharing may be increased and thus the size of the work area within which data may be shared and compared may be increased. In still another embodiment, data may be transmitted to the on-board controller 48 through the wireless network system 121 associated with command center 120.

At decision stage 73, the on-board controller 48 may determine the type of machine from which the productivity data was received at stage 72. If the productivity data is for a different type of machine, the on-board controller 48 may discard or disregard that the data for the purpose of determining a high-performance reference for that machine. In other words, the on-board controller 48 may discard or disregard at stage 74 data received for any type of machine that is sufficiently different from the type of machine processing the data. In instances in which the peer-to-peer communications system 49 is used to share information from other machines, the on-board controller 48 may pass the disregarded data to other machines.

If the productivity data is for a similar type of machine, the on-board controller 48 may store at stage 75 a plurality of the productivity data from the other machines. At stage 76, the on-board controller 48 may utilize the stored productivity data received from other similar machines to determine or generate a high performance reference for the type of material moving operation. To do so, the on-board controller 48 may analyze one or more performance parameters and select one or more specific material moving operations having the highest productivity which then define one or more desired performance parameters. The on-board controller 48 may then determine one or more tuning parameters associated with the highest productivity material moving operations which then define one or more desired tuning parameters

In one example, the on-board controller 48 may select the material moving operation having the highest productivity over a predetermined time period (e.g., one hour of operation) or a predetermined number of material moving operations and utilize the tuning parameters associated with that material moving operation as a target or desired tuning parameters. In another example, the on-board controller 48 may select a predetermined number of material moving operations having the highest productivity over a predetermined time period (e.g., one hour of operation) or a predetermined number of material moving operations and average or use another process to establish the target or desired performance parameters and their associated tuning parameters.

The on-board controller 48 may be configured to store the data to create a stored history of a plurality of reference operations. As additional material moving operations or cycles are completed, new data may be generated and the stored history updated. In some instances, the amount of stored data may be increased. In other instances, the amount of data may remain generally constant with old data discarded as new data is generated. The data may be updated continuously or updated at predetermined intervals such as in batches. This process may create an ongoing cache of up-to-date data that may be used for determining the high performance reference.

At stage 77, the machine 10 may be operated to perform the desired operation. The controller may receive at stage 78 data from the sensors of the machine 10. At stage 79, the on-board controller 48 may determine the performance parameter or parameters for the operation being performed. In addition, the on-board controller 48 may determine at stage 80 a plurality of tuning parameters associated with the operation being performed. The on-board controller 48 may utilize the peer-to-peer communications system 49 to transmit at stage 81 the productivity data (i.e., the performance parameters and the tuning parameters) to other machines 10.

The on-board controller 48 may compare at decision stage 82 the on-board performance parameters from the completed material moving operation to the performance parameters of the high-performance reference. If the on-board performance parameters are greater than or equal to the performance parameters of the high-performance reference at decision stage 83, operation of machine 10 may continue and stages 72-83 repeated. Although described in the context of comparing the on-board performance parameters and on-board tuning parameters for a particular material moving operation to those of the high-performance reference, an average of the on-board performance parameters and their associated on-board tuning parameters from a particular number of material moving operations or time period may be compared to the high-performance reference, if desired.

If the on-board performance parameters are less than the performance parameters of the high-performance reference, the on-board controller 48 may determine at decision stage 84 whether the difference between the on-board performance parameters from the completed material moving operation and the high-performance reference parameters exceeds a threshold. If the difference is less than the threshold, operation of machine 10 may continue and stages 72-84 repeated.

If the difference is greater than or equal to the threshold, on-board controller 48 may provide notice at stage 85 to desired personnel or systems. In an example in which the machine 10 is being operated manually, management personnel such as a supervisor or foreman may be informed and the management personnel may make a decision as to whether and how to inform the machine operator. In addition or in the alternative, the on-board controller 48 may be configured to display feedback and suggestions on how the operator may improve their performance. For example, the on-board controller 48 may display a comparison between the on-board tuning parameters for a particular material moving operation or an average from a particular number of material moving operations and the tuning parameters for the high-performance reference.

The on-board controller 48 may also store instructional materials such as instructional video or animation and written or verbal suggestions on how an operator may improve their performance with respect to each tuning parameters. Based upon the feedback and/or instructions regarding the operator's performance, the machine operator may adjust the operation of the machine 10 at stage 86 and the operation of machine may continue and stages 72-86 repeated.

In an example in which the machine 10 is being operated autonomously or semi-autonomously, management personnel such as a supervisor or foreman may be informed at stage 84. In addition or alternatively, an operator responsible for the operation of the machine 10 may also be informed. In order to improve the performance of the material moving operations, settings or assumptions that affect or control the material moving operation or plan may be adjusted at stage 86 based upon a comparison of the on-board tuning parameters for a particular material moving operation and the tuning parameters for the high-performance reference. After adjusting the operation of the machine 10 at stage 85, the operation of machine may continue and stages 72-86 repeated.

It should be noted that the threshold utilized at stage 84 may be different depending upon the manner in which the machine 10 is being operated. In an example in which a machine 10 is being operated manually, the threshold may be set at, for example, ten percent so that the operator may continue to operate the machine without notice being generated unless the difference is sufficiently large. In an example in which a machine 10 is being operated autonomously or semi-autonomously, the threshold may be set at a lower percentage (e.g., five percent) since adjusting the operation of an autonomous or semi-autonomous machine may be made more easily through a numerical adjustment within the on-board controller 48 while adjustments made by a machine operator operating manually may be more difficult to perform.

Although the operation of performance evaluation and feedback system 60 associated with FIG. 5 is generally described in the context of peer-to-peer communication between machines, the process is equally applicable to systems that utilize peer-to-peer communications system 49 together with wireless network system 121 or the wireless network system by itself. For example, the desired performance parameters and desired tuning parameters may be stored within controller 46, either on-board or off-board machine 10.

Further, at stage 72, rather than transmitting productivity data between machines 10, the machines may transmit productivity data through the wireless network system 121 to an off-board portion of controller 46 (e.g., such as at a command center 120) that operates to analyze the productivity data and generate a high performance reference including performance parameters and tuning parameters for each type of machine. The high-performance reference may be sent to each machine 10 and the on-board controller 48 may continue to operate with respect to stages 77-86 except that stage 81 may be modified as described above so that the productivity data from each machine is transmitted to an off-board portion of controller 46 and the analyses, including determining the high performance reference, may be determined off-board the machine 10. Thus, the performance evaluation and feedback system 60 may include steps that are generated or processed, on-board, off-board, or a combination of the two.

If desired, performance evaluation and feedback system 60 may further include a process in which the actual performance of the machine 10 may be compared to one or more general thresholds to determine whether the machine is being operated at substantially above or below an expected range of operations. For example, in some instances, the performance parameters or the tuning parameters may indicate that the machine 10 is being operated in an unsafe manner or one that may cause damage or wear to the machine. In other instances, the performance parameters or the tuning parameters may indicate that the machine 10 is being operated at a rate or in a manner that is substantially below an expected performance level. In any of the foregoing cases, the controller 46 may be configured to provide notice and adjust the operation of the machine, even without utilizing the high-performance reference.

More specifically, performance evaluation and feedback system 60 may further include storing one or more performance parameter thresholds and/or one or more tuning parameter thresholds within controller 46 such as before stage 70 in FIG. 5. These performance parameter thresholds may be stored at any desired location including on-board or off-board machine 10. In addition, the performance evaluation and feedback system 60 may include, such as between stages 80 and 81, the step of comparing the performance parameters and the tuning parameters associated with a material moving cycle to the performance parameter thresholds and the tuning parameter thresholds, respectively. If a performance parameter exceeds its performance parameter threshold or a tuning parameter exceeds its tuning parameter threshold, the controller 46 may be configured to skip the analysis of stages 82-84 and provide notice at stage 85 and potentially adjust the operation of machine 10 at stage 86. In such case, the operation of the machine 10 may be immediately adjusted and the undesired machine operation prevented. In addition, poor performance data may not be sent off-board at stage 81.

### INDUSTRIAL APPLICABILITY

The industrial applicability of the system described herein will be readily appreciated from the forgoing discussion. The foregoing discussion is applicable to machines 10 that are operated at a work site 100 to perform various operations. Such system may be used at a mining site, a landfill, a quarry, a construction site, a roadwork site, a forest, a farm, or any other area in which machine operation is desired.

Machine operators often perform repetitive operations at a work site 100 such as to move material from one location to another. Some of the operations may be segmented or broken into a plurality of quantitatively measurable tasks or tuning parameters. For example, some of the tasks may involve moving a machine 10 or components of the machine (e.g., base portion 21, implement support portion 22, lift arms 31, and/or bucket 34) in a specified manner such as with the components positioned in a desired manner or moving at a desired rate.

The performance of one machine 10 as compared to others at a work site 100 may be evaluated by comparing performance parameters for each machine that are indicative of the efficiency of material moving operations performed by the machines. A target or high performance reference may be set or determined based upon a plurality of operations of at least one other machine at a work site. Operation of a machine 10 may be compared to the high performance reference to determine whether the machine is operating above or below the reference.

If the machine 10 is operating below the high performance reference, tuning parameters that evaluate the position and movement of the machine and its components may be compared to tuning parameters associated with the high performance reference to identify reasons for the differences in performance. Immediate feedback may be provided to a supervisor and/or an operator. Based upon such feedback, changes in material moving operations may be implemented. For example, in manually operated machines, suggestions or instructional information may be provided to the machine operator. In autonomously or semi-autonomously operated machines, factors and assumptions associated with material movement plans may be adjusted. In each instance, changes may be made based upon the high performance reference to improve the productivity of the material moving process.

It will be appreciated that the foregoing description provides examples of the disclosed system and technique. However, it is contemplated that other implementations of the disclosure may differ in detail from the foregoing examples. All references to the disclosure or examples thereof are intended to reference the particular example being discussed at that point and are not intended to imply any limitation as to the scope of the disclosure more generally. All language of distinction and disparagement with respect to certain features is intended to indicate a lack of preference for those features, but not to exclude such from the scope of the disclosure entirely unless otherwise indicated.

Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context.

Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein or otherwise clearly contradicted by context.

1. A system for providing feedback for a machine operation performed by a first machine, the machine operation corresponding to a first type of machine operation and including a tuning parameter associated therewith, the tuning parameter being quantitatively measurable, comprising:
a work implement for moving material at a work site to perform the machine operation; and
a controller configured to:
generate a high performance reference based upon a plurality of reference operations performed by at least another machine, the plurality of reference operations corresponding to the first type of machine operation;
determine a performance parameter for the machine operation performed by the first machine;
compare the performance parameter to the high performance reference; and
generate a notice upon a difference between the performance parameter and the high performance reference exceeding a threshold.

2. The system of claim 1, wherein the plurality of reference operations are performed by a plurality of machines, each of the plurality of machines being generally similar to the first machine.

3. The system of claim 1, further including a peer-to-peer communications system configured to transmit productivity data between the at least another machine and the first machine.

4. The system of claim 3, wherein the peer-to-peer communications system is further configured to transmit productivity data between a plurality of machines in addition to the first machine, and the controller is further configured to generate the high performance reference based upon the productivity data transmitted between the plurality of machines.

5. The system of claim 1, wherein the at least another machine is generally similar to the first machine.

6. The system of claim 1, wherein the plurality of reference operations are generally similar to the machine operation.

7. The system of claim 1, further including a sensor operative to determine a tuning parameter associated with the work implement.

8. The system of claim 7, further including a linkage member operatively connected to the work implement and a second sensor operative to determine a second tuning parameter associated with the linkage member.

9. The system of claim 8, further including a linkage having the linkage member and a second linkage member, the linkage member being pivotable relative to the second linkage member, the work implement being operatively connected to one of the linkage member and the second linkage member.

10. The system of claim 7, wherein one of the tuning parameter and the second tuning parameter is an angular velocity of one of the work implement and the linkage member.

11. The system of claim 1, further including a plurality of tuning parameters associated with each machine operation.

12. The system of claim 1, wherein the controller is further configured to select ones of the plurality of reference operations to generate the high performance reference.

13. The system of claim 1, wherein the high performance reference includes a plurality of desired tuning parameters.

14. The system of claim 13, wherein the machine operation includes a plurality of tuning parameters associated therewith and the controller is further configured to compare the plurality of tuning parameters associated with the machine operation to the plurality of desired tuning parameters.

15. The system of claim 14, wherein the controller is further configured to provide feedback based upon a difference between the plurality of tuning parameters associated with the machine operation and the plurality of desired tuning parameters.

16. The system of claim 13, wherein controller is further configured to determine the high performance reference based upon a stored history of the plurality of reference operations, the stored history being updated at predetermined intervals.

17. The system of claim 1, wherein the controller is configured to determine the high performance reference on-board the first machine.

18. The system of claim 1, wherein the controller is configured to determine the high performance reference off-board the first machine.

19. A method of providing feedback for a machine operation performed by a first machine, the machine operation corresponding to a first type of machine operation and including a tuning parameter associated therewith, the tuning parameter being quantitatively measurable, the method comprising:
generating a high performance reference based upon a plurality of reference operations performed by at least another machine, the plurality of reference operations corresponding to the first type of machine operation;
determining a performance parameter for the machine operation performed by the first machine as a work implement moves material at a work site;
comparing the performance parameter to the high performance reference; and
generating a notice upon a difference between the performance parameter and the high performance reference exceeding a threshold.

20. A machine comprising:
a propulsion system for moving the machine;
a work implement for moving material at a work site to perform the machine operation, the machine operation corresponding to a first type of machine operation and including a tuning parameter associated therewith, the tuning parameter being quantitatively measurable; and
a controller configured to:
generate a high performance reference based upon a plurality of reference operations performed by at least another machine, the plurality of reference operations corresponding to the first type of machine operation;
determine a performance parameter for the machine operation performed by the machine;
compare the performance parameter to the high performance reference; and
generate a notice upon a difference between the performance parameter and the high performance reference exceeding a threshold.
